(19) United States
(12) Patent Application Publication
(10) Pub. No.: US 2014/0040649 A1
(43) Pub. Date: Feb. 6, 2014

(54) Charging Method and an Electronic Apparatus Using Thereof

(71) Applicant: Pegatron Corporation, Taipei (TW)

(72) Inventor: Yong-Der Lee, Taipei (TW)

(21) Appl. No.: 13/934,487

(22) Filed: Jul. 3, 2013

(30) Foreign Application Priority Data
Aug. 1, 2012 (TW) 101127865

(51) Int. Cl. G06F 1/32

(52) U.S. Cl. CPC G06F 1/3234
USPC 713/323

(57) ABSTRACT

A charging method and an electronic apparatus using thereof are provided. In the method, an initialization procedure is executed firstly for putting a central processor in a non-working state and charging a battery via a charging circuit. Next, after the battery is charged for a first preset time, an interrupting signal is outputted via the charging circuit so as to wake up the central processor and stop charging the battery, so that the central processor is switched from the non-working state to a working state, according to the interrupting signal. The central processor in the working state detects the battery state parameter of the battery. Finally, the initialization procedure mentioned above is re-executed.

### CROSS-REFERENCES TO RELATED APPLICATIONS

This non-provisional application claims priority under 35 U.S.C.§119(a) on Patent Application No. 101127865 filed in Taiwan, R.O.C. on 2012 Aug. 1, the entire contents of which are hereby incorporated by reference.

### BACKGROUND

1. Technical Field

The disclosure relates to a charging method, and particularly to a charging method and an electronic apparatus using thereof.

2. Related Art

Along with the innovation of technologies, numerous electronic apparatuses (such as mobile phones, digital cameras, MP3 players and so forth), have appeared to the markets, and even become a necessity part for a person in daily life. The electronic apparatuses are assembled with batteries so they can be operated anywhere with convenience. Particularly, rechargeable batteries are applied to the electronic apparatuses, so that the batteries do not need to be substituted frequently. Consequently, the electronic apparatuses commonly have charging circuits to charge the rechargeable batteries.

FIG. 1 is a block diagram view of a charging circuit 110 of a conventional electronic apparatus 100. The charging circuit 110 includes a power input end 112, a system electricity power providing end 114, a battery electricity power providing end 116 and a control end 118. The power input end 112 receives an outer AC power source 200 and convert the AC power source 200 to a DC power source, so that the DC power source is provided for a system loading 140 in the system electricity providing end 114 and for a battery 160 in the battery electricity providing end 116 respectively. A controlling chip 180 of the conventional electronic apparatus 100 is connected to the control end 118 to control and supervise the charging state of the charging circuit 110 so as to check the state of the battery 160 in anytime or after charging the battery 160 for a preset time. Once an abnormal condition occurs, the charging is stopped or the parameter is reset so as to continue the charging.

Commonly, the controlling chip 180 is a central processor which runs the main functions of the conventional electronic apparatus 100 (such as running the operating system of the conventional electronic apparatus). During charging, the central processor must periodically check the state of the battery 160 in anytime or after counting for the preset time, therefore during charging, the central processor still must consume an intrinsic working efficiency, so that the charging efficiency for the battery 160 is reduced. In order to improve on the disadvantages mentioned above, a micro controller having lower power consumption is applied to substitute the controlling chip 180 as the central processor; however, the manufacturing costs will be increased, and even running the micro controller leads intrinsic power consumption.

### SUMMARY

In view of this, the present invention proposes a charging method and an electronic apparatus using thereof to resolve the problems occurred in the prior arts.

A charging method of one concept of the present invention is applicable for an electronic apparatus having a central processor, a charging circuit and a battery. The charging method includes (a) executing an initialization procedure, (b) outputting an interrupting signal and stopping charging the battery after the battery is charged by the charging circuit for a first preset time, (c) switching the central processor from a non-working state to a working state according to the interrupting signal and (d) executing the above steps from (a) to (c).

In some implementation aspects, the initialization procedure includes: acquiring a battery state parameter of the battery, setting a charging parameter of the charging circuit according to the battery state parameter and putting the central processor in the non-working state, such as a sleeping state or a turn-off state.

In some implementation aspects, the charging method further includes following steps: receiving a controlling signal momentarily come from the battery, according to the controlling signal, switching the central processor from the non-working state to the working state and determining the state of the battery so as to stop charging the battery or to execute step (d) to continue charging the battery when an abnormal condition occurs.

An electronic apparatus of one concept of the present invention includes a battery, a charging circuit and a central processor. The charging circuit is connected electrically to the battery and the central processor. The charging circuit is provided to charge the battery. After the battery is charged for a first preset time, the charging circuit outputs an interrupting signal. The central processor is provided to receive the interrupting signal, according to the interrupting signal, the central processor is switched from a non-working state to a working state and executes an initialization procedure. The initialization procedure includes: acquiring the battery state parameter of the battery, setting a charging parameter of the charging circuit according to the battery state parameter and putting the central processor to in the non-working state.

In some implementation aspects, the central processor receives a controlling signal momentarily come from an inner controller of the battery. According to the controlling signal, the central processor is switched from the non-working state to the working state and determines the state of the battery so as to stop charging the battery or to restart the initialization procedure to continue charging the battery when an abnormal condition occurs.

Based on this, via the charging method and an electronic apparatus used by the present invention, the power consumption of the central processor is reduced during charging, so that the electricity resource can be saved and the charging time can be shortened. Further, the life time of the battery is extended due to intermittent charging. Based on this, the problem of reduced charging efficiency, which occurs in prior arts and results from the reason that the charging chip must be continuously running during charging so as to control and supervise the charging state, can be solved.

The detailed features and advantages of the present invention are described below in great detail through the following embodiments, the content of the detailed description is sufficient for those skilled in the art to understand the technical content of the present invention and to implement the present invention there accordingly. Using the content of the specification, the claims, and the drawings, those skilled in the art can easily understand the relevant objectives and advantages of the present invention.

### BRIEF DESCRIPTION OF THE DRAWINGS

The present invention will become more fully understood from the detailed description given herein below for illustration only, and thus not limitative of the present invention, wherein:

FIG. 1 is a block diagram view of a charging circuit of a conventional electronic apparatus;

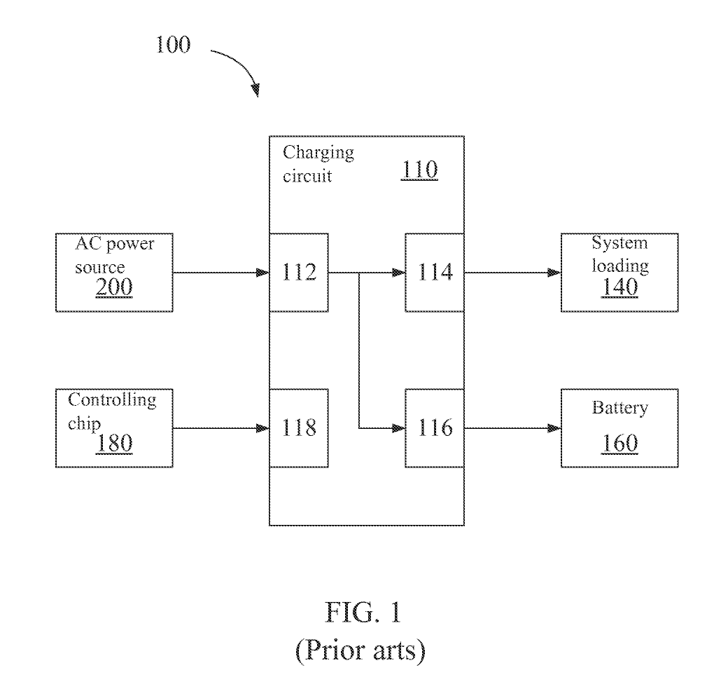

FIG. 2 is a block diagram view of an electronic apparatus of the present invention;

FIG. 3 is another block diagram view of the electronic apparatus of the present invention;

FIG. 4 is a circuit schematic view of the electronic apparatus of the present invention;

FIG. 5 is a hardware block diagram view of the electronic apparatus of the present invention; and

FIG. 6 is a schematic flow chart of a charging method of the present invention.

### DETAILED DESCRIPTION

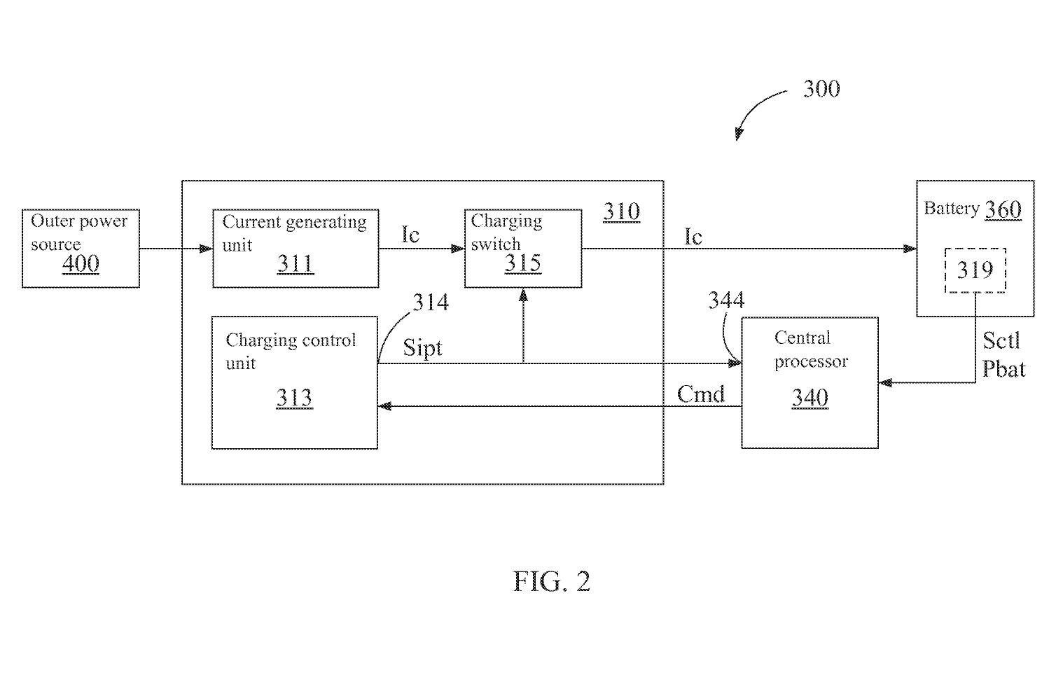

FIG. 2 is a block diagram view of an electronic apparatus 300 of the present invention.

As shown in FIG. 2, the electronic apparatus 300 includes a battery 360, a charging circuit 310 and a central processor 340. The charging circuit 310 is connected electrically between the battery 360 and an outer power source 400. The charging circuit 310 is connected electrically to the central processor 340. Here, the outer power source 400 is an AC power source, but embodiments of the present invention are not limited thereto; in some embodiments, the outer power source 400 is a DC power source.

The charging circuit 310 generates a charging current Ic according to the electricity from the outer power source 400 so as to provide the charging current Ic to the battery 360 (that is to say, to charge the battery 360). After the battery 360 is charged for a first preset time, the charging circuit 310 outputs an interrupting signal Sipt and stops charging the battery 360.

The central processor 340 executes an initialization procedure. The initialization procedure includes acquiring a battery state parameter Pbat of the battery 360, setting a charging parameter according to the battery state parameter Pbat and putting the central processor 340 in a non-working state.

The central processor 340 receives the interrupting signal Sipt so as to be switched from the non-working state to a working state for detecting the battery state parameter Pbat of the battery 360. If the battery state parameter Pbat is within a preset interval, the charging parameter of the charging circuit 310 is reset (namely, the charging circuit 310 is reset), so as to continue charging the battery 360, or to apply an emergency dealing procedure to the battery 360 and to switch the central processor 340 to the non-working state eventually.

Here, the non-working state mentioned above is a sleeping state or a turn-off state. That is to say, during charging the battery 360, the central processor 340 is in the sleeping state or the turn-off state so as to reduce the power consumption. After the battery 360 is charged for the first preset time, the central processor 340 is recovered to the working state from the sleeping state or the turn-off state so as to confirm the state of the battery 360.

In one embodiment, the battery 360 includes an inner controller 319 so as to supervise the state of the battery 360 in anytime, such as the electric quantity, the temperature or so forth. The inner controller 319 outputs a controlling signal Sctl according to the state of the battery 360. The central processor 340 receives the controlling signal Sctl momentarily come from the inner controller 319 of the battery 360; then, according to the controlling signal Sctl, the central processor 340 is switched from the non-working state to the working state and determines the state of the battery 360 so as to stop charging the battery 360 or to process the initialization procedure mentioned above to charge the battery 360 when an abnormal condition occurs.

In some embodiments, as shown in FIG. 2, the charging circuit 110 includes a current generating unit 311, a charging control unit 313 and a charging switch 315.

The current generating unit 311 is provided to generate the charging current Ic. The current generating unit 311 is connected electrically to the outer power source 400 so as to generate the charging current Ic according to the electricity from the outer power source 400. A first end of the charging switch 315 is connected electrically to the battery 360. A second end of the charging switch 315 is connected electrically to the current generating unit 311 so as to receive the charging current Ic.

The charging control unit 313 includes an interrupting control end 314. The interrupting control end 314 is connected electrically to a control end of the charging switch 315 to output the interrupting signal Sipt to turn off the charging switch 315 after the battery 360 is charged for the first preset time. After the charging switch 315 is turned off, the charging current Ic cannot be delivered to the battery 360, so that the charging circuit 310 stops charging the battery 360.

Besides being connected electrically to the control end of the charging switch 315, the interrupting control end 314 is further connected electrically to a state trigger pinout 344 of the central processor 340. When the state trigger pinout 344 detects the interrupting signal Sipt, the central processor 340 is switched from the non-working state to the working state.

That is to say, when the interrupting signal Sipt stops charging the battery 360, the central processor 340 is also recovered to the working state because of the interrupting signal Sipt so as to check the state of the battery 360 via the central processor 340 in the same moment.

In some embodiments, when the battery state parameter Pbat is within the preset interval and after the central processor 340 is switched to the working state for a second preset time, the central processor 340 resets the charging circuit 310 and is switched to the non-working state.

That is to say, the central processor 340 is in the non-working state for the first preset time, and is in the working state for the second preset time. In addition, during the first preset time, the battery 360 is charged; during the second preset time, the battery 360 is not charged. Based on this, the central processor 340 does not need to be in the working state consistently, thus reducing the power consumption of the central processor 340; further, by charging the battery 360 intermittently, battery aging and over discharge problems can be prevented.

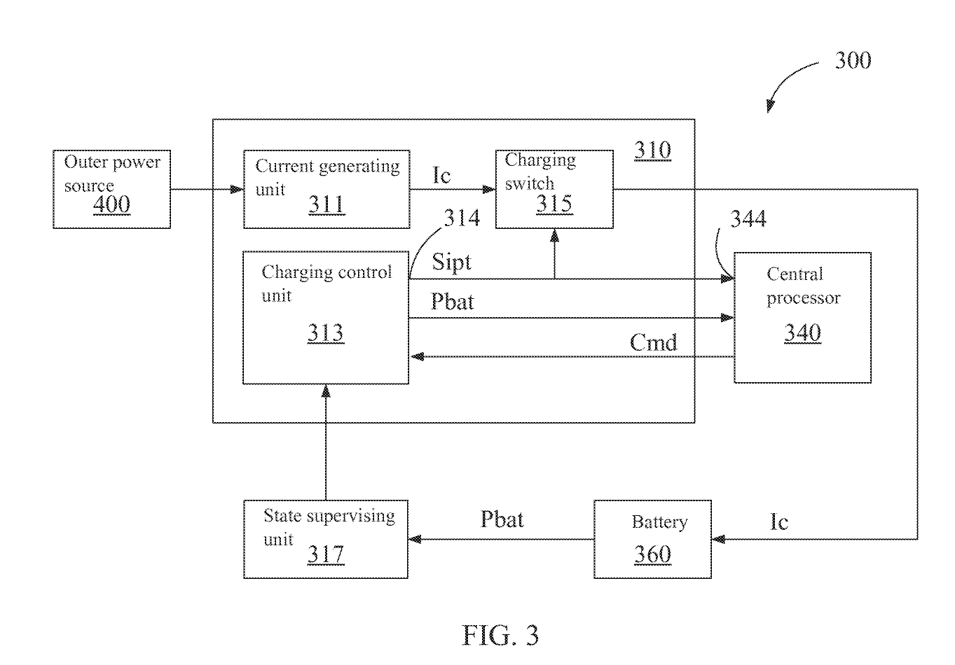

FIG. 3 is another block diagram view of the electronic apparatus 300 of the present invention.

As shown in FIG. 3, in one embodiment, the electronic apparatus 300 further includes a state supervising unit 317. The state supervising unit 317 is connected electrically to the battery 360 and the central processor 340 so as to read the battery state parameter Pbat from the battery 360 (or the inner controller 319), and send the battery state parameter Pbat to the central processor 340. That is to say, the central processor 340 is signally connected to the battery 360 directly to acquire the battery state parameter Pbat or indirectly acquires the battery state parameter Pbat via the state supervising unit 317.

Here, the state supervising unit 317 is embodied by a gauge IC, and the charging control unit 313 is embodied by a charge IC. The gauge IC is coupled with the charging IC and is connected electrically to the central processor 340 via the charge IC so as to send the battery state parameter Pbat to the central processor 340.

Therefore, the central processor 340 is connected electrically to the charging control unit 313 so as to acquire the battery state parameter Pbat of the battery 360 and reset the charging parameter of the charging circuit 310 according to the battery state parameter Pbat. For example, the central processor 340 resets a sequential logic state of the charging control unit 313 so as to lead the charging control unit 313 returning back to the initial state for restarting a new charging circle.

In some embodiments, the battery state parameter Pbat detected by the central processor 340 is the temperature of the battery 360. Namely, after the battery 360 is charged for the first preset time, the central processor 340 confirms whether the temperature of the battery 360 is above a preset threshold or not; if not, the charging of the battery 360 is continued, but embodiments of the present invention are not limited thereto. In some embodiments, the battery state parameter Pbat detected by the central processor 340 is a connection parameter of the battery 360 which represents whether the battery 360 is connected electrically to the charging circuit 310 (or the state supervising unit 317), properly, so as to prevent the charging circuit 310 from continuing charging when the battery 360 is removed.

In some embodiments, the battery state parameter Pbat detected by the central processor 340 is the electric quantity of the battery 360. Namely, if the central processor 340 detects the electric quantity of the battery 360 is full, the battery 360 will not be charged.

Operating principles of the electronic apparatus 300 according with the present invention are detailed elucidated as following.

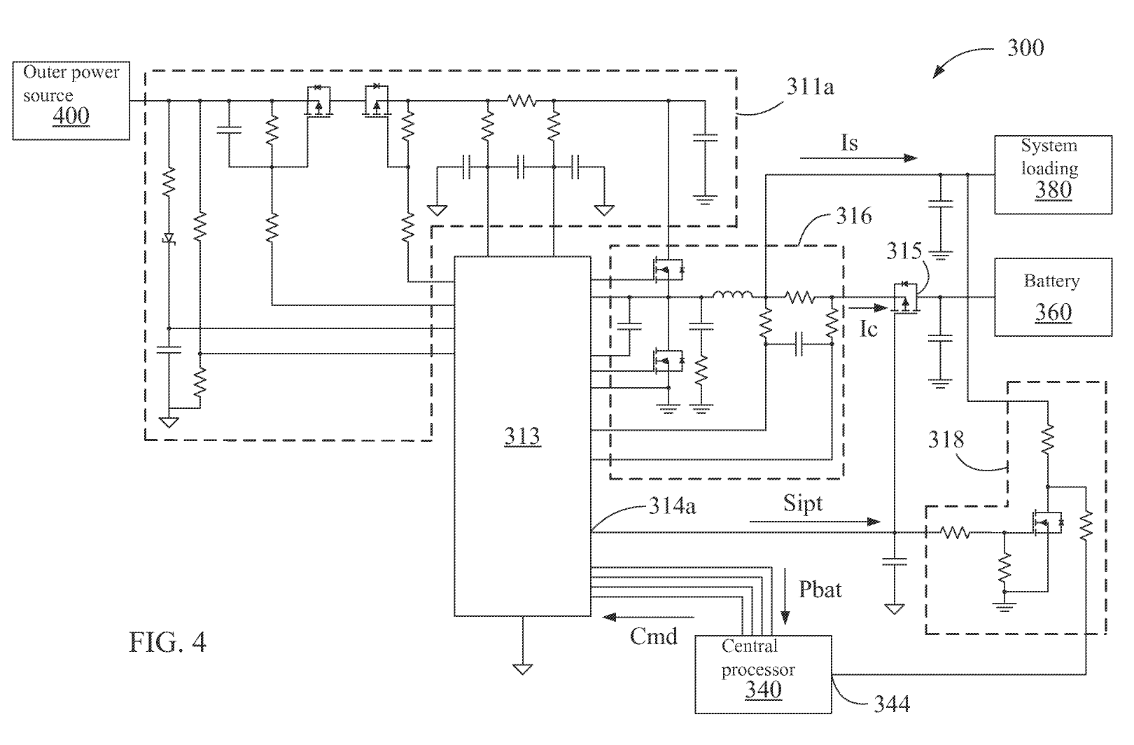

FIG. 4 is a circuit schematic view of the electronic apparatus 300 of the present invention.

Please refer to FIGS. 3-4, in which the current generating unit 311 is substantially embodied by an AC-to-DC circuit 311 a so as to convert the AC power from the outer power source 400 to the DC power. The charging control unit 313 can be a charging IC (model number ISL9519) made by INTERSIL AMERICAS INC. The charging control unit 313 is connected electrically to the AC-to-DC circuit 313a and a buck-boost circuit 316 so as to control the AC-to-DC circuit 313a and the buck-boost circuit 316.

The AC-to-DC circuit 313a is connected electrically to the buck-boost circuit 316 so as to output the converted DC power to the buck-boost circuit 316. The buck-boost circuit 316 is controlled by the charging control unit 313 to adjust the voltage of the DC power so as to output a system current Is to a system loading 380 (the electricity for running the electronic apparatus 300), and to output the charging current Ic to the battery 360 through the charging switch 315.

The first end of the charging switch 315 is connected electrically to the battery 360, the second end of the charging switch 315 is connected electrically to the buck-boost circuit 316, and the control end of the charging switch 315 is connected electrically to an interrupting control pinout 314a of the charging control unit 313. Based on this, the charging control unit 313 controls the charging switch 315 to be turned on or off according to the interrupting signal Sipt so as to determine if the charging current Ic is outputted to the battery 360 through the charging switch 315 or not.

As shown in FIG. 4, the interrupting control pinout 314a is connected electrically to the state trigger pinout 344 of the central processor 340 via a buffer circuit 318 so as to correspond to the interrupting signal Sipt to trigger the central processor 340 switching from the non-working state to the working state.

The central processor 340 is connected electrically to the charging control unit 313 and the battery 360 so as to communicate with the charging control unit 313. The central processor 340 can send a request to the charging control unit 313 for acquiring the battery state parameter Pbat so as to receive the battery state parameter Pbat from the charging control unit 313 in which the charging control unit 313 acquires the battery state parameter Pbat from the state supervising unit 317 (not shown in FIG. 4). When the battery state parameter Pbat is within the preset interval, the central processor 340 sends a reset command Cmd to the charging control unit 313 so as to turn on the charging switch 315 and continue charging the battery 360. The central processor 340 and the charging control unit 313 can communicate with each other via UART interfaces, SPI interfaces, I²C interfaces, I²S interfaces or so forth.

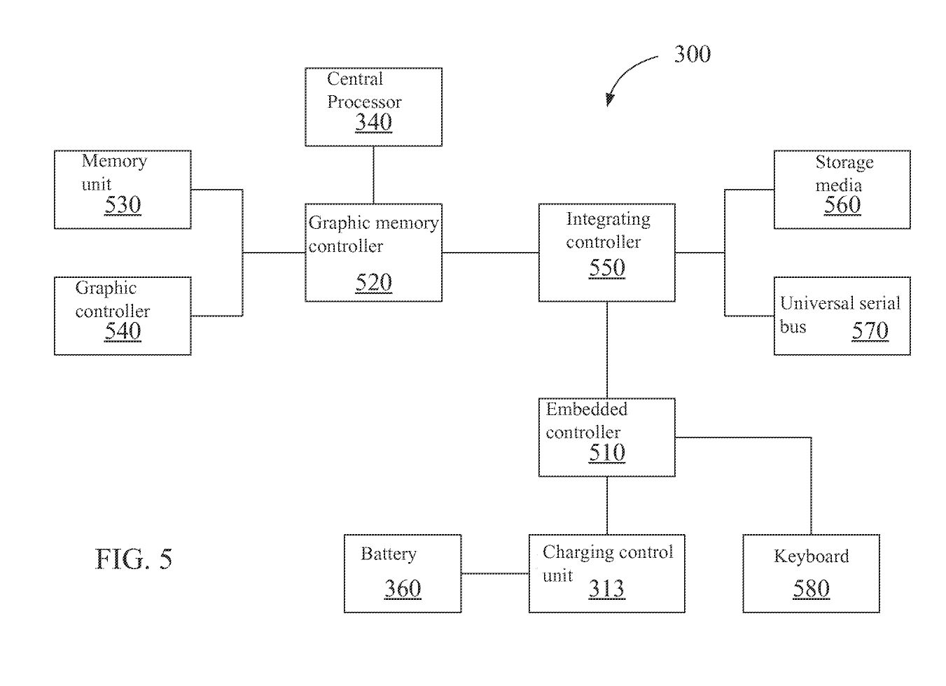

FIG. 5 is a hardware block diagram view of the electronic apparatus 300 of the present invention.

Here, when the electronic apparatus 300 is a tablet PC, a mobile phone or other mobile electronic device, the central processor 340 is substantially a processor having Advanced RISC Machine (ARM) architecture. Therefore, the central processor 340 is directly connected to the charging control unit 313, but embodiments of the present invention are not limited thereto. For instance, the electronic apparatus 300 can be a notebook PC. Under this condition, the central processor 340 is connected to the charging control unit 313 via an embedded controller 510 of the electronic apparatus 300 so as to receive the battery state parameter Pbat and the interrupting signal Sipt to send the reset command Cmd, as shown in FIG. 5.

That is to say, according to the hardware architecture of the electronic apparatus 300, the central processor 340 can directly connected to the charging control unit 313 or indirectly connected to the charging control unit 313 via other electronic components, but the connection relationship between the electronic components is not limited to what FIG. 4 shown.

As shown in FIG. 5, besides the battery 360, the central processor 340 and the embedded controller 510, the electronic apparatus 300 further includes a graphic memory controller 520 (such as a north bridge chip), a memory unit 530, a graphic controller 540, an integrating controller 550 (such as a south bridge chip), a storage media 560 (such as a hard disk), an universal serial bus 570 (USB), and a keyboard 580. Ordinary skill in the art should realize and be capable of knowing the operating principles of the electronic components mentioned above, so that the operating principles of the electronic components mentioned is omitted.

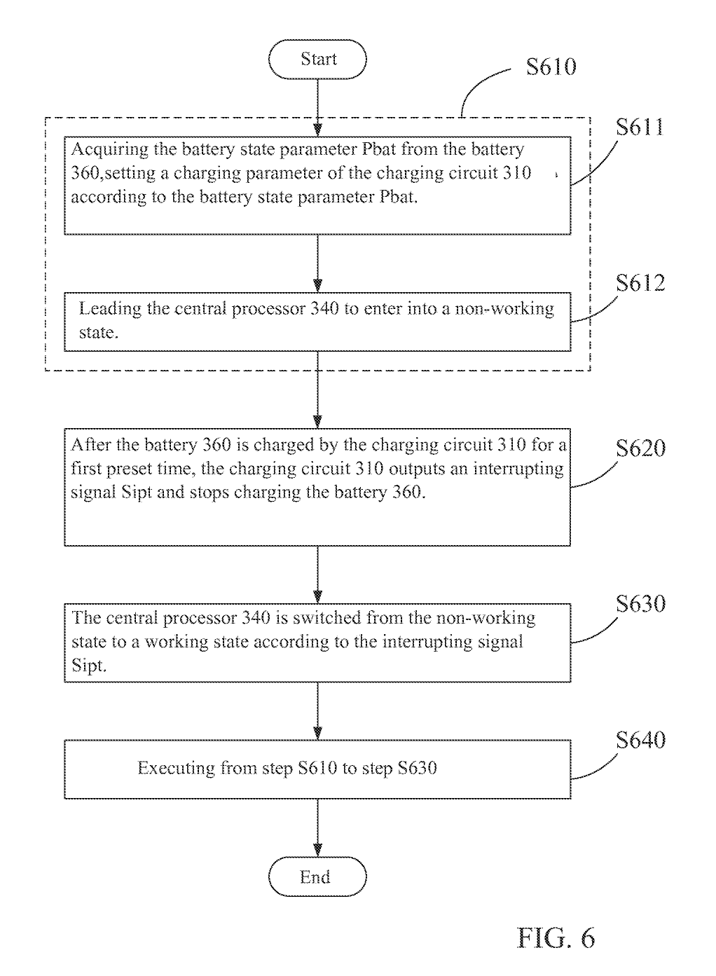

FIG. 6 is a schematic flow chart of a charging method of the present invention.

The charging method shown in FIG. 6 is applicable to the electronic apparatus 300 mentioned above.

Firstly, the initialization procedure is executed (step S610), to acquire the battery state parameter Pbat of the battery 360; then the charging parameter of the charging circuit 310 is set according to the battery state parameter Pbat (step S611), so as to put the central processor 340 in the non-working state (step S612). After the battery 360 is charged by the charging circuit 310 for the first preset time, the charging circuit 310 outputs the interrupting signal Sipt and stops charging the battery 360 (step S620). The central processor 340 is switched from the non-working state to the working state according to the interrupting signal Sipt (step S630). Finally, step S610 and step S630 are repeated (step S640).

When step S640 is finished and step S610 is re-executed, the battery state parameter Pbat of the battery 360 is acquired, so that the central processor 340 resets the charging parameter of the charging circuit 310 according to the battery state parameter Pbat. That is to say, when the battery state parameter Pbat is within the preset interval, the charging parameter of the charging circuit 310 is reset so as to continue charging the battery 360. Based on this, by repeating steps from step S610 to step S630, the battery 360 can be charged intermittently.

Once the battery state parameter Pbat is out of the preset interval, the charging method is terminated.

In some embodiments, the charging method further includes following steps.

Firstly, receiving the controlling signal Sctl momentarily come from the battery 360, wherein the controlling signal Sctl is generated according to the state of the battery 360; for example, when the temperature of the battery 360 is abnormal. Thereby, the central processor 340 is switched from the non-working state to the working state according to the controlling signal Sctl. Hence, in the working state, the central processor 340 determines the state of the battery 360 so as to stop charging the battery 360 when the abnormal condition occurs, otherwise to continue processing step S640 to charge the battery 360.

In some embodiments, the charging method further includes a counting step: starting to count after the central processor 340 is switched to the working state. The charging method further includes a waiting step: if the battery state parameter Pbat is within the preset interval, repeat the initialization procedure (step S610), after counting to the second preset time. That is to say, in step S630, the initialization procedure (step S610), is not executed as soon as the central processor 340 is switched to the working state; instead, after the central processor 340 is switched to the working state for the second preset time, the initialization procedure (step S610), is executed. Based on this, via controlling the ratio between the times the battery 360 is not charged (the second preset time), and the times the battery 360 is charged (the first preset time), an intermittent charging method is provided.

Supposed that the first preset time is 175 seconds and the second preset time is 1 second. If the working voltage of the central processor 340 is 5 V, the current consumed by the central processor 340 in the working state is 200 mA, the current consumed by the central processor 340 in the sleeping state is 3 mA and the current consumed by the central processor 340 in a turn-off state is 0 mA. Therefore, the power consumption of the central processor 340 of the electronic apparatus 300 applied with the charging method of the present invention is reduced from 1 W to 15 mW, namely, 98.5% of the power consumption of the central processor 340 is saved. Additionally, if within the first preset time, the central processor 340 is switched to the turn-off state, more than 99% of the power consumption of the central processor 340 is saved.

In one embodiment, the battery 360 is a Li-ion battery or a Li-Polymer battery, but embodiments of the present invention are not limited thereto.

Based on this, by means of the charging method and an electronic apparatus using thereof of the present invention, the power consumption of the central processor 340 is reduced during charging, so that the consumed electricity resource can be saved and the charging time can be shortened. Additionally, the life time of the battery 360 is extended because of the intermittent charging. Based on this, problem of reducing the charging efficiency, which occurs in prior arts and results from the reason that the charging chip must be continuously running during charging so as to control and supervise the charging state, can be solved.

While the present invention has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A charging method, applicable for an electronic apparatus having a central processor, a charging circuit and a battery, comprising:
(a) executing an initialization procedure, comprising:
acquiring a battery state parameter of the battery, setting a charging parameter of the charging circuit according to the battery state parameter; and
putting the central processor in a non-working state;
(b) outputting an interrupting signal and stopping charging the battery after the battery is charged by the charging circuit for a first preset time;
(c) switching the central processor from the non-working state to a working state according to the interrupting signal; and
(d) executing steps from (a) to (c).

2. The charging method according to claim 1, further comprising:
receiving a controlling signal come from the battery;
switching the central processor from the non-working state to the working state according to the control signal;
determining the state of the battery so as to stop charging the battery when an abnormal condition occurs, otherwise to execute step (d).

3. The charging method according to claim 1, wherein the battery state parameter is optionally selected as the temperature of the battery or the electric quantity of the battery.

4. The charging method according to claim 1, wherein the non-working state is optionally selected as a sleeping state or a turn-off state.

5. An electronic apparatus, comprising:
a battery;
a charging circuit, connected electrically to the battery, provided to output an interrupting signal and to stop charging the battery after charging the battery for a first preset time; and
a central processor, connected electrically to the charging circuit so as to be switched from a non-working state to a working state and execute an initialization procedure according to the interrupting signal, wherein the initialization procedure comprising:
acquiring a battery state parameter of the battery, setting a charging parameter of the charging circuit according to the battery state parameter; and
putting the central processor in the non-working state.

6. The electronic apparatus according to claim 5, wherein the charging circuit comprising:
a current generating unit, generating a charging current;
a charging switch, a first end of the charging switch is connected electrically to the battery, a second end of the charging switch is connected electrically to the current generating unit so as to receive the charging current; and
a charging control unit, comprising an interrupting control end, the interrupting control end is connected electrically to a control end of the charging switch to output the interrupting signal to turn off the charging switch after the battery is charged for the first preset time, the interrupting control end of the charging control unit is connected electrically to a state trigger pinout of the central processor, when the state trigger pinout detects the interrupting signal, the central processor is switched from the non-working state to the working state.

7. The electronic apparatus according to claim 5, wherein the central processor is signally connected to the battery so as to acquire the battery state parameter and set the charging parameter of the charging circuit according to the battery state parameter.

8. The electronic apparatus according to claim 5, wherein after the central processor is switched to the working state for a second preset time, the central processor sets the charging parameter of the charging circuit.

9. The electronic apparatus according to claim 5, wherein the central processor receives a controlling signal come from an inner controller of the battery, so that the central processor is switched from the non-working state to the working state according to the controlling signal and determines the state of the battery so as to stop charging the battery or to process the initialization procedure to charge the battery when an abnormal condition occurs.

10. The electronic apparatus according to claim 5, wherein the battery state parameter is optionally selected as the temperature of the battery or the electric quantity of the battery.

11. The electronic apparatus according to claim 5, wherein the non-working state is optionally selected as a sleeping state or a turn-off state.
